(19) United States
(12) Patent Application Publication
(10) Pub. No.: US 2026/0164130 A1
(43) Pub. Date: Jun. 11, 2026

(54) ELECTRONIC DEVICE

(71) Applicant: CANON KABUSHIKI KAISHA, Tokyo (JP)

(72) Inventor: YOHEI TOYOHARA, Kanagawa (JP)

(21) Appl. No.: 19/374,087

(22) Filed: Oct. 30, 2025

(30) Foreign Application Priority Data
Dec. 11, 2024 (JP) 2024-216318

(51) Int. Cl. H04N 23/68; G06F 3/01

(52) U.S. Cl. CPC H04N 23/683; G06F 3/016; H04N 23/6812

(57) ABSTRACT

An electronic device according to the present disclosure includes a processor, and a memory storing a program which, when executed by the processor, causes the electronic device to execute acquisition processing of acquiring at least one of a video signal and a sound signal, execute improvement processing of improving quality of a signal to be acquired by the acquisition processing, and execute control processing of recording a signal whose quality is improved by the improvement processing and information regarding a processing amount of the improvement processing in association with each other.

### BACKGROUND

### Field of the Technology

The present disclosure relates to an electronic device, and particularly, to a technology for presenting a pseudo haptic sensation.

### Description of the Related Art

A haptic sensation presentation device (haptics device) that presents a pseudo haptic sensation to a user by vibrating a vibration device with a predetermined drive waveform or controlling a temperature of a device surface has been proposed. At the time of viewing content such as a game or a movie, by presenting a pseudo haptic sensation corresponding to a viewing scene of content by using a haptic sensation presentation device provided in a display device or a controller, a realistic feeling of the content can be enhanced.

In addition, the performance of an imaging device is significantly improved, and the quality of a video and a sound can be improved by camera shake correction of the video, sound noise removal, and the like.

When the realistic feeling of content is enhanced by the haptic sensation presentation, it is important to present a feature of a capturing environment with the haptic sensation presentation. However, when improvement in the quality such as camera shake correction and noise removal is performed, characteristics of the capturing environment are removed from the video and sound. Thus, it is difficult to present a suitable haptic sensation from a video signal or a sound signal after the improvement in the quality. In the technology disclosed in Japanese Patent Laid-Open No. 2020-24686, haptic sensation information is generated on the basis of a sound signal, but it is not possible to generate haptic sensation information that causes a user to feel wind from the sound signal after wind noise is removed by noise removal.

### SUMMARY

The present disclosure provides a technology capable of presenting a suitable haptic sensation even in a case where quality of a video signal or a sound signal is improved.

The present disclosure in its first aspect provides an electronic device including a processor, and a memory storing a program which, when executed by the processor, causes the electronic device to execute acquisition processing of acquiring at least one of a video signal and a sound signal, execute improvement processing of improving quality of a signal to be acquired by the acquisition processing, and execute control processing of recording a signal whose quality is improved by the improvement processing and information regarding a processing amount of the improvement processing in association with each other.

The present disclosure in its second aspect provides a control method of an electronic device, including acquiring at least one of a video signal and a sound signal, executing processing of improving quality of a signal to be acquired, and recording a signal whose quality is improved and information regarding a processing amount of the processing in association with each other.

The present disclosure in its third aspect provides a non-transitory computer readable medium that stores a program, wherein the program causes a computer to execute a control method of an electronic device, the control method including acquiring at least one of a video signal and a sound signal, executing processing of improving quality of a signal to be acquired, and recording a signal whose quality is improved and information regarding a processing amount of the processing in association with each other.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an imaging device.

FIG. 2 is a block diagram illustrating a configuration of a control unit of the imaging device.

FIG. 3 is a flowchart illustrating processing of an anti-vibration haptic sensation information generation unit.

FIG. 4 is a flowchart illustrating processing of a sound haptic sensation information generation unit.

FIG. 5 is a block diagram illustrating configurations of an image processing unit and a control unit of the imaging device.

FIG. 6A is an external view of an imaging system.

FIG. 6B is a block diagram illustrating a configuration of a sub-information acquisition unit.

FIG. 7 is a flowchart illustrating processing of the image processing unit of the sub-information acquisition unit.

### DESCRIPTION OF THE EMBODIMENTS

### First Embodiment

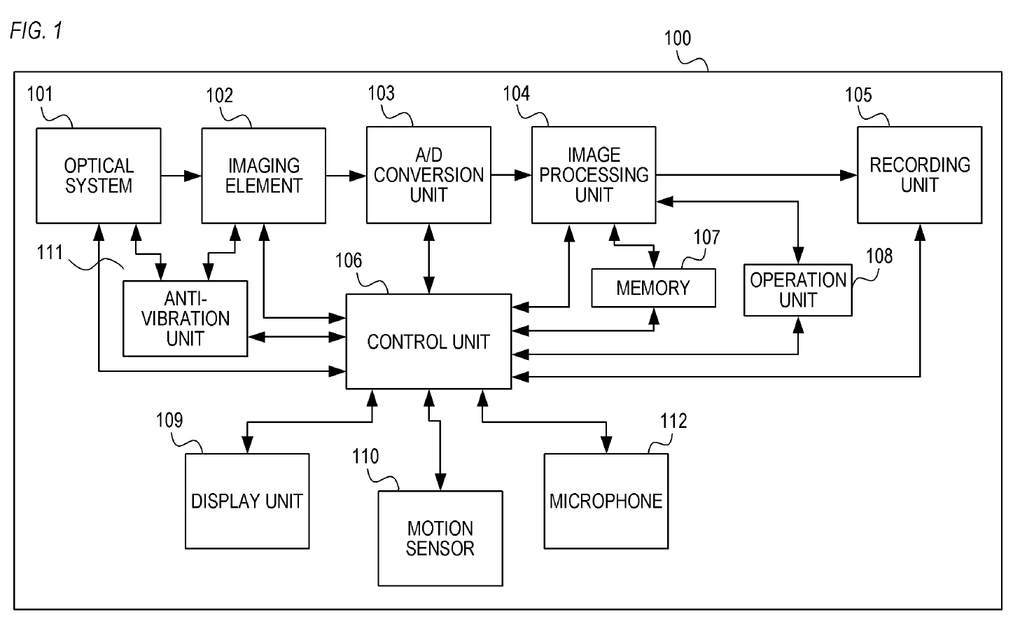

Hereinafter, a first embodiment of the present disclosure will be described. FIG. 1 is a block diagram illustrating a configuration of an imaging device 100 according to the first embodiment. The imaging device 100 includes an optical system 101, an imaging element 102, an A/D conversion unit 103, an image processing unit 104, a recording unit 105, a control unit 106, a memory 107, an operation unit 108, a display unit 109, a motion sensor 110, an anti-vibration unit 111, and a microphone 112.

The optical system 101 includes a focus lens, a diaphragm, and a shutter. An object can be focused by driving the focus lens, and an exposure amount can be adjusted by controlling the diaphragm and the shutter.

The imaging element 102 is a photoelectric conversion element such as a CCD or a CMOS that converts light incident on the imaging element 102 from the object via the optical system 101 (an optical image formed on the imaging element 102 by the optical system 101) into an electric signal by photoelectric conversion.

The A/D conversion unit 103 digitizes an electric signal (analog signal) acquired by the imaging element 102 to acquire a video signal which is a digital signal.

The image processing unit 104 performs image processing such as synchronization processing, white balance correction processing, and gamma processing on the video signal obtained by the A/D conversion unit 103, and outputs the video signal after the image processing to the recording unit 105.

The recording unit 105 records the video signal output from the image processing unit 104 on a recording medium (not illustrated). In a case where a still image is recorded, the recording unit 105 converts an image format of the video signal output from the image processing unit 104 into JPEG or the like. In a case where a moving image is recorded, the recording unit 105 converts the image format of the video signal output from the image processing unit 104 into mp4 or the like. The recording unit 105 can also record a sound signal (to be described later) output from the control unit 106 on the recording medium. The recording unit 105 can also record various types of information such as haptic sensation information in association with a signal to be recorded (a video signal or a sound signal) as meta information.

The control unit 106 controls an operation of the imaging device 100. In the first embodiment, the control unit 106 determines a processing amount (anti-vibration amount) of anti-vibration processing performed by the anti-vibration unit 111, and generates the haptic sensation information. The control unit 106 can also correct the sound signal output from the microphone 112 and output a sound signal after the correction to the recording unit 105.

The memory 107 stores various types of information such as information (for example, illumination information used for the white balance correction processing) used by the image processing unit 104 and settings related to capturing.

The operation unit 108 receives an operation (instruction) for the imaging device 100 from a user. The operation unit 108 may have an operation member such as a button, or may acquire information of an operation performed by the user by using the operation member of an external device for the imaging device 100 from the external device in a wired or wireless manner.

The display unit 109 is, for example, a liquid crystal display, and displays various images such as a screen for assisting an operation by the user, a live video imaged (captured) by the imaging element 102, and a video recorded by the recording unit 105. A touch panel may be integrally provided with the display unit 109.

The motion sensor 110 detects motion of the imaging device 100 and outputs a detection result. The motion sensor 110 includes, for example, an acceleration sensor, a gyro sensor, and the like.

The anti-vibration unit 111 performs anti-vibration processing of moving at least one of the optical system 101 and the imaging element 102 so as to offset the motion of the imaging device 100 on the basis of the output (detection result of the motion) of the motion sensor 110. The anti-vibration processing may be interpreted as processing of removing vibration caused by vibration of the imaging device 100 from the video represented by the output (video signal) of the image processing unit 104. The anti-vibration processing improves the quality of the video signal input to the image processing unit 104 and the recording unit 105.

The microphone 112 detects sound around the imaging device 100 and outputs a sound signal representing the sound.

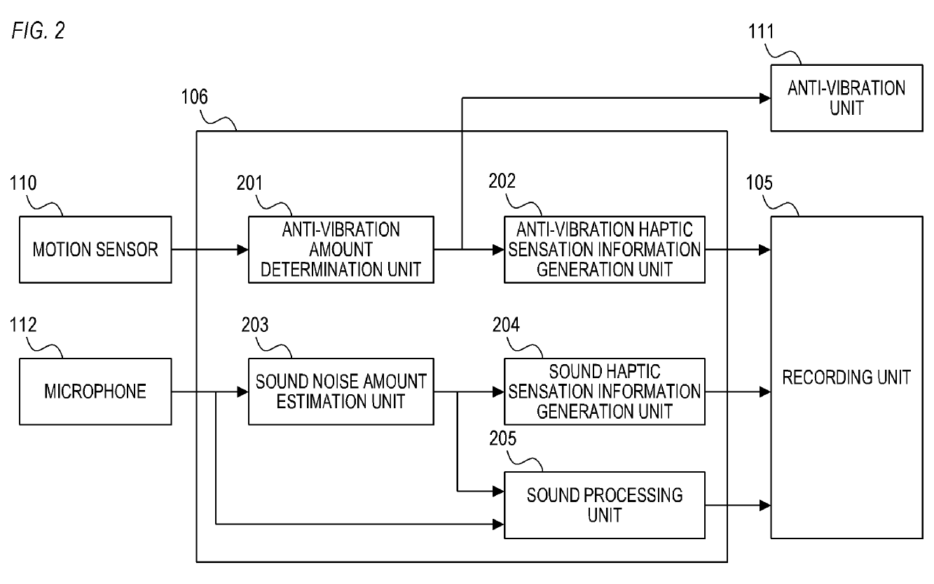

FIG. 2 is a block diagram illustrating a configuration of the control unit 106. The control unit 106 includes an anti-vibration amount determination unit 201, an anti-vibration haptic sensation information generation unit 202, a sound noise amount estimation unit 203, a sound haptic sensation information generation unit 204, and a sound processing unit 205.

The anti-vibration amount determination unit 201 determines a processing amount (anti-vibration amount) of the anti-vibration processing on the basis of the output (detection result of the motion) of the motion sensor 110. The anti-vibration unit 111 performs the anti-vibration processing with the anti-vibration amount determined by the anti-vibration amount determination unit 201.

The anti-vibration haptic sensation information generation unit 202 generates haptic sensation information (information indicating a haptic sensation) on the basis of the anti-vibration amount determined by the anti-vibration amount determination unit 201. For example, the anti-vibration haptic sensation information generation unit 202 generates haptic sensation information for presenting vibration removed from the video by the anti-vibration processing (vibration of the imaging device 100 that is no longer expressed by the video by the anti-vibration processing) with the haptic sensation. In the first embodiment, it is assumed that haptic sensation information indicating a frequency and an intensity of vibration for reproducing a haptic sensation is generated.

The sound noise amount estimation unit 203 extracts a noise signal (noise component) from the output (sound signal) of the microphone 112 and outputs the extracted noise signal to the sound haptic sensation information generation unit 204 and the sound processing unit 205. A method for extracting the noise signal is not particularly limited, and noise information may be extracted by analyzing a waveform of the sound signal, or a preset type of noise signal may be extracted. For example, the user designates a type of noise sound to be removed, such as wind noise or machine vibration sound. The sound noise amount estimation unit 203 extracts, as the noise signal, a frequency component corresponding to the designated type from the sound signal.

The sound processing unit 205 performs noise removal processing of removing the noise signal extracted by the sound noise amount estimation unit 203 from the output (sound signal) of the microphone 112, and outputs a sound signal after the noise removal processing to the recording unit 105. The quality of the sound signal input to the recording unit 105 is improved by the noise removal processing. The noise signal may be interpreted as a processing amount of the noise removal processing. Similarly to the image processing unit 104, the sound processing unit may be an external element of the control unit 106. The image processing unit 104 may be an internal element of the control unit 106.

The sound haptic sensation information generation unit 204 generates the haptic sensation information on the basis of the noise signal extracted by the sound noise amount estimation unit 203. For example, haptic sensation information for presenting a feature removed from the sound signal by the noise removal processing with the haptic sensation is generated. In the first embodiment, it is assumed that haptic sensation information indicating a frequency and an intensity of vibration for reproducing a haptic sensation is generated.

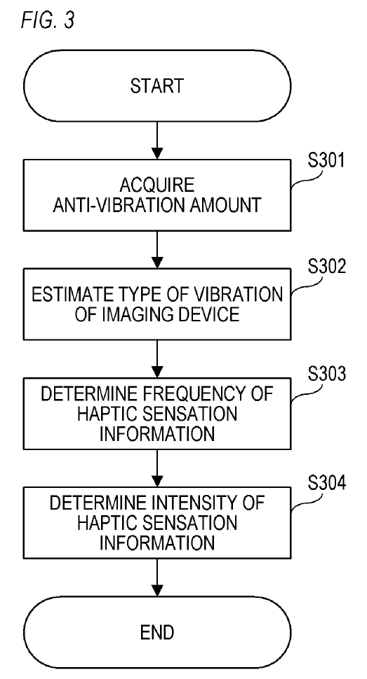

FIG. 3 is a flowchart illustrating processing of the anti-vibration haptic sensation information generation unit 202.

In S301, the anti-vibration haptic sensation information generation unit 202 acquires the anti-vibration amount from the anti-vibration amount determination unit 201.

In S302, the anti-vibration haptic sensation information generation unit 202 analyzes the anti-vibration amount acquired in S301 to estimate the type (cause) of the vibration occurring in the imaging device 100. Here, the vibration generated in the imaging device 100 may be interpreted as vibration to be removed by the anti-vibration processing. For example, vibration with an intensity lower than a predetermined intensity is estimated to be vibration due to a slight camera shake of the user who holds the imaging device 100 and stands still. In a case where vibration with an intensity higher than the predetermined intensity occurs at a predetermined frequency (cycle), this vibration is estimated to be vibration caused by walking of the user holding the imaging device 100. In a case where the vibration with the predetermined intensity continues, this vibration is estimated to be vibration caused by movement of the user holding the imaging device 100 by a moving body.

In S303, the anti-vibration haptic sensation information generation unit 202 determines the frequency of the vibration for reproducing the haptic sensation on the basis of the type estimated in S302. For example, a correspondence relationship between the type of the vibration of the imaging device 100 and the frequency of the vibration for reproducing the haptic sensation is determined in advance and stored in the memory 107. Then, the anti-vibration haptic sensation information generation unit 202 determines a frequency corresponding to the type estimated in S302 while referring to the memory 107.

In S304, the anti-vibration haptic sensation information generation unit 202 determines the intensity (amplitude) of vibration for reproducing the haptic sensation on the basis of the anti-vibration amount (a magnitude of the vibration of the imaging device 100) acquired in S301. For example, a relational expression between the anti-vibration amount and the intensity of the vibration for reproducing the haptic sensation is determined in advance, and the anti-vibration haptic sensation information generation unit 202 calculates the intensity from the anti-vibration amount acquired in S301 by using the relational expression. For example, the anti-vibration haptic sensation information generation unit 202 determines (calculates) a higher intensity as the anti-vibration amount is larger.

The anti-vibration haptic sensation information generation unit 202 generates haptic sensation information indicating the frequency determined in S303 and the intensity determined in S304.

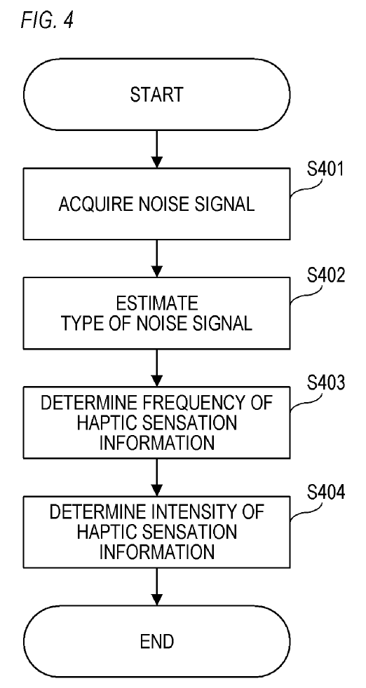

FIG. 4 is a flowchart illustrating processing of the sound haptic sensation information generation unit 204.

In S401, the sound haptic sensation information generation unit 204 acquires the noise signal from the sound noise amount estimation unit 203.

In S402, the sound haptic sensation information generation unit 204 acquires information of the type of the noise signal (the type designated by the user) acquired in S401.

In S403, the sound haptic sensation information generation unit 204 determines the frequency of the vibration for reproducing the haptic sensation on the basis of the type acquired in S402. For example, a correspondence relationship between the type of the noise signal and the frequency of the vibration for reproducing the haptic sensation is determined in advance and stored in the memory 107. Then, the sound haptic sensation information generation unit 204 determines the frequency corresponding to the type acquired in S402 while referring to the memory 107.

In S404, the sound haptic sensation information generation unit 204 determines the intensity (amplitude) of the vibration for reproducing the haptic sensation on the basis of the noise signal acquired in S401. For example, a relational expression between a magnitude of the noise signal and the intensity of the vibration for reproducing the haptic sensation is determined in advance, and the sound haptic sensation information generation unit 204 calculates the intensity of the vibration from the magnitude of the noise signal acquired in S401 by using the relational expression. For example, the sound haptic sensation information generation unit 204 determines (calculates) a higher intensity as the noise signal is larger.

The sound haptic sensation information generation unit 204 generates haptic sensation information indicating the frequency determined in S403 and the intensity determined in S404.

As described above, according to the first embodiment, the video signal and the sound signal are acquired, and the processing of improving the quality of the acquired signal (improvement in the quality) is performed. Then, a signal after the quality improvement and information regarding the processing amount of improving the quality (haptic sensation information on the basis of the processing amount) are recorded in association with each other. In this way, even in a case where information is removed from the video signal or the sound signal due to the improvement in the quality of the video signal or the sound signal, a suitable haptic sensation (a haptic sensation related to the removed information) is presentable to the user on the basis of the recorded information (haptic sensation information).

Note that, although an example in which the motion of the imaging device 100 is detected by the motion sensor 110 has been described, the method of detecting the motion is not limited thereto. For example, the motion of the imaging device 100 may be detected by detecting a temporal change in the video signal. For the processing of detecting the temporal change in the video signal, for example, an optical flow for detecting motion vectors from two consecutive image frames can be used. In addition, although an example in which mechanical anti-vibration processing of moving at least one of the optical system 101 and the imaging element 102 is performed has been described, the anti-vibration processing is not limited thereto. For example, the anti-vibration processing may be electronic anti-vibration processing of deforming an image on the basis of the detection result of the motion. Only one or both of the mechanical anti-vibration processing and the electronic anti-vibration processing may be performed.

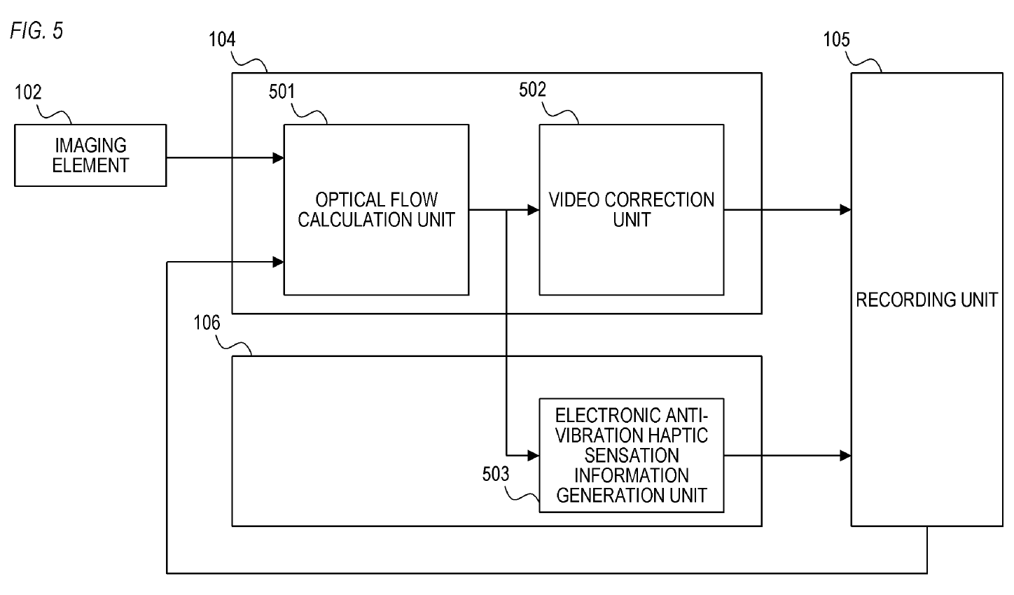

FIG. 5 is a block diagram illustrating configurations of the image processing unit 104 and the control unit 106 in a case where an optical flow is used. The image processing unit 104 includes an optical flow calculation unit 501 and a video correction unit 502, and the control unit 106 includes an electronic anti-vibration haptic sensation information generation unit 503. In FIG. 5, elements related to the sound signal are omitted.

The optical flow calculation unit 501 acquires a video signal of a current frame (current frame) from the imaging element 102, and acquires a video signal of a previous frame (a previous frame of the current frame) from the recording unit 105. The optical flow calculation unit 501 extracts (detects) a plurality of feature points from each of the acquired video signals of the two frames, and calculates a motion vector of each feature point between the two frames. Then, the optical flow calculation unit 501 outputs a motion vector group corresponding to the plurality of feature points to the video correction unit 502 and the electronic anti-vibration haptic sensation information generation unit 503 of the control unit 106.

On the basis of the motion vector group output from the optical flow calculation unit 501, the video correction unit 502 performs geometric deformation on a video signal of the current frame so as to reduce the motion of the feature point from the previous frame. Then, the video correction unit 502 outputs a video signal after the geometrical deformation to the recording unit 105. Consequently, the quality of the video signal input to the recording unit 105 is improved.

The electronic anti-vibration haptic sensation information generation unit 503 determines a representative motion vector representing the motion vector group on the basis of the motion vector group output from the optical flow calculation unit 501. Then, the electronic anti-vibration haptic sensation information generation unit 503 generates haptic sensation information by performing processing similar to that of the anti-vibration haptic sensation information generation unit 202 by using the representative motion vector as the above-described anti-vibration amount.

The imaging device 100 is not limited to a digital camera, and may be, for example, a smartphone or a tablet terminal. In addition, although an example in which the present disclosure is applied to the imaging device has been described, the present disclosure may be applied to an electronic device different from the imaging device. For example, the present disclosure is also applicable to a controller, a smartphone, a tablet terminal, and the like connected to the imaging device. The present disclosure may be applied to an editing device that edits content such as video and music.

Although an example in which the haptic sensation information indicates both the frequency and the intensity of the vibration has been described, the haptic sensation information may indicate only one of the frequency and the intensity of the vibration. In addition, although an example in which the haptic sensation by the vibration of the device is presented has been described, the method for presenting the haptic sensation is not particularly limited. For example, the haptic sensation may be presented by a temperature, or the haptic sensation may be presented by an ultrasonic wave. Although an example in which both the video signal and the sound signal are acquired and recorded (improved in the quality) has been described, only one of the video signal and the sound signal may be acquired and recorded (with the improvement in the quality).

Although an example in which the haptic sensation information is associated with the video signal or the sound signal has been described, the information associated with the video signal or the sound signal is not limited to the haptic sensation information as long as the information relates to the processing amount for the improvement in the quality. For example, the information associated with the video signal or the sound signal may include information indicating the type and magnitude of the vibration removed by the anti-vibration processing, information indicating the output of the motion sensor or the temporal change in the video signal, information indicating the type and magnitude of the noise signal removed by the noise removal processing, and the like.

### Second Embodiment

A second embodiment of the present disclosure will be described. Note that, hereinafter, description of configurations and processing similar to those of the first embodiment will be omitted, and configurations and processing different from those of the first embodiment will be described.

In the first embodiment, the haptic sensation information (the haptic sensation information on the basis of the processing amount for the improvement in quality) based on the information removed from the signal due to the improvement in the quality of the signal (the video signal and the sound signal) is generated and recorded. In the second embodiment, information that regards the video signal before the improvement in the quality and is not obtainable from a video signal before the improvement in the quality or a video signal after the improvement in the quality (information that does not appear in the video signal before the improvement in the quality or the video signal after the improvement in the quality) is acquired. Then, the acquired information (haptic sensation information that is not obtainable from the video signal before the improvement in the quality or the video signal after the improvement in the quality) is recorded in association with the signal (video signal or sound signal).

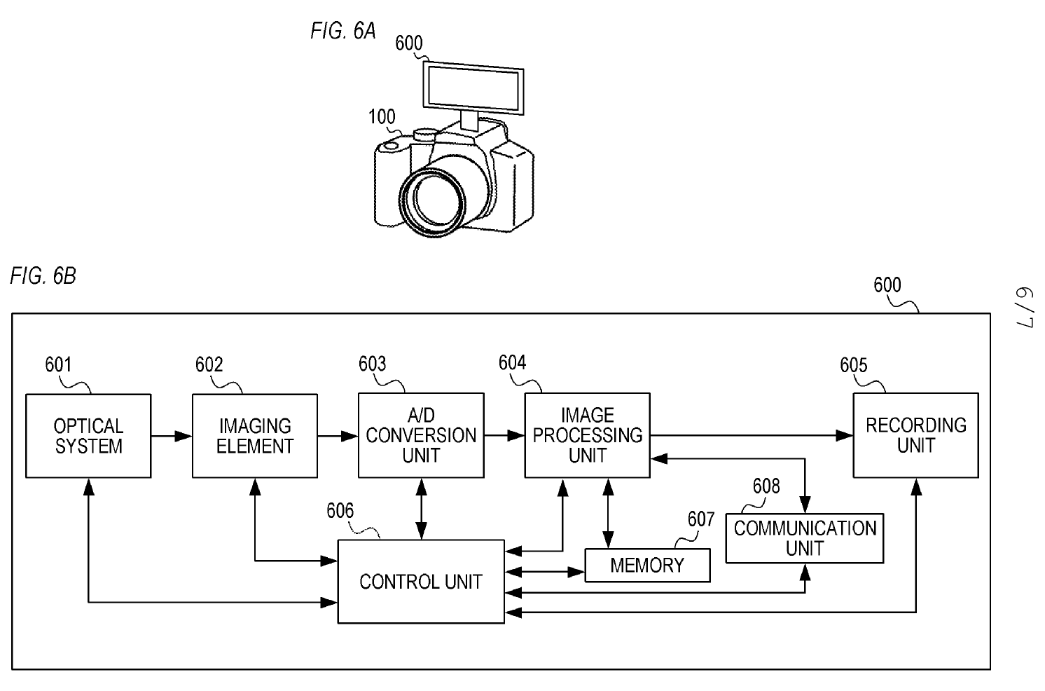

FIG. 6A is an external view of an imaging system according to the second embodiment. As illustrated in FIG. 6A, in the second embodiment, a sub-information acquisition unit 600 is attached to the imaging device 100. For example, the sub-information acquisition unit 600 is an imaging device that images a range different from an imaging range of the imaging device 100 (such as a range including an image capturing person (photographer) of the imaging device 100).

FIG. 6B is a block diagram illustrating a configuration of the sub-information acquisition unit 600. The sub-information acquisition unit 600 includes an optical system 601, an imaging element 602, an A/D conversion unit 603, an image processing unit 604, a recording unit 605, a control unit 606, a memory 607, and a communication unit 608. The optical system 601, the imaging element 602, the A/D conversion unit 603, the recording unit 605, the control unit 606, and the memory 607 have functions similar to those of the optical system 101, the imaging element 102, the A/D conversion unit 103, the recording unit 105, the control unit 106, and the memory 107 of the imaging device 100, respectively.

Similarly to the image processing unit 104, the image processing unit 604 performs image processing such as synchronization processing, white balance correction processing, and gamma processing on the video signal obtained by the A/D conversion unit 603. Further, the image processing unit 604 detects a main object (for example, the face of the image capturing person) from the video represented by the video signal, and estimates an expression and an emotion of the main object from a video of the main object. Various existing methods can be applied to the detection of the main object. Various existing methods can also be applied to the estimation of the expression and emotion of the main object. The image processing unit 604 generates haptic sensation information on the basis of the estimated expression or emotion, and outputs the video signal and the haptic sensation information to the recording unit 605.

The communication unit 608 performs communication with the imaging device 100 (a communication unit (not illustrated) included in the imaging device 100). The communication unit 608 receives a control signal corresponding to an operation by the user from the imaging device 100, and outputs, to the imaging device 100, the video signal and the haptic sensation information output from the image processing unit 604 to the recording unit 605. The control unit 106 of the imaging device 100 performs control such that the signal after the improvement in the quality, the haptic sensation information on the basis of the processing amount of the improvement in the quality, the video signal acquired from the sub-information acquisition unit 600 and the haptic sensation information acquired from the sub-information acquisition unit 600 are recorded in association with each other.

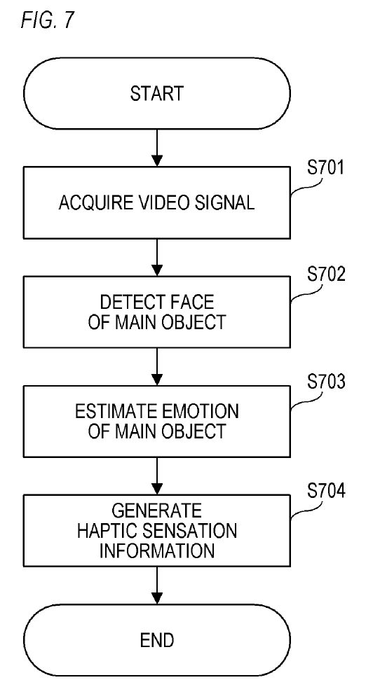

FIG. 7 is a flowchart illustrating processing of the image processing unit 604.

In step S701, the image processing unit 604 acquires a video signal imaged by the imaging element 602 and converted into a digital signal by the A/D conversion unit 603.

In S702, the image processing unit 604 detects the face of the main object from the video (for example, an image of one frame) represented by the video signal acquired in S701. For example, the image processing unit 604 detects one or more faces from the video and determines a detected largest face as the face of the main object.

In S703, the image processing unit 604 estimates the emotion of the main object detected in S702. For example, the image processing unit 604 estimates the emotion of the main object on the basis of facial organs such as the eyes, mouth, and nose of the main object. The facial organ can be detected from the video (face image) of the main object. The facial organ of the main object may be detected in a procedure of detecting the face of the main object, or the facial organ of the main object may be detected after the face of the main object is detected. A size of the facial organ and a position (for example, a position of a mouth corner) of a feature point of the facial organ depend on the expression. For example, a size of the eye and a position of a feature point of the eye are different between when the eye is open and when the eye is closed. Similarly, a size of the mouth and a position of a feature point of the mouth are different between when the mouth is open and when the mouth is closed. It is assumed that dictionary data in which a set (feature amount vector) of sizes of a plurality of facial organs and positions (coordinates) of feature points of the plurality of facial organs is associated with emotions is prepared in advance. In this case, an emotion corresponding to a feature amount vector of the main object can be determined as the emotion of the main object while referring to the dictionary data.

In S704, the image processing unit 604 generates haptic sensation information on the basis of the emotion estimated in S703. For example, haptic sensation information for presenting a change in the body (for example, a change in a heart rate) associated with the emotion estimated in S703 with a haptic sensation is generated. For example, in a case where the estimated emotion is “impatience”, it is estimated that the heart of the main object is moving faster than usual. Thus, in a case where the estimated emotion is “impatience”, haptic sensation information indicating vibration of a high frequency (for example, 120 Hz) is generated.

As described above, according to the second embodiment, information (second information) that regards the video signal of the imaging device 100 and is not obtainable from the video signal is acquired. Then, the signal after the improvement in the quality, the information regarding the processing amount of the improvement in the quality, and the second information are recorded in association with each other. In this way, in addition to the effect of the first embodiment, it is possible to obtain an effect that a haptic sensation on the basis of the information not obtainable from the video signal of the imaging device 100 is presentable to the user.

Note that, although an example in which the emotion of the main object is estimated in S703 has been described, the heart rate of the main object may be estimated on the basis of a temporal change (moving image) in the face of the main object in S703. Then, in S704, the haptic sensation information may be generated on the basis of the estimated heart rate.

Although an example in which the sub-information acquisition unit 600 is the imaging device has been described, the sub-information acquisition unit 600 may be a position sensor that detects an imaging position, or may be an air temperature sensor that detects an air temperature at the imaging position (around the imaging device 100).

An example in a case where the sub-information acquisition unit 600 is the air temperature sensor will be described. In a case where the sub-information acquisition unit 600 is the air temperature sensor, the sub-information acquisition unit 600 estimates a change in the body of the main object on the basis of the detected air temperature, and generates haptic sensation information. For example, in the case of a low air temperature at which a person shakes, haptic sensation information indicating vibration of the same cycle (frequency) as that of the human shake is generated. In the case of a high air temperature at which a person is short of breath, haptic sensation information indicating vibration having a cycle similar to a cycle of breathing at the time of shortness of breath is generated. The haptic sensation information may be generated such that a haptic sensation is presented at a temperature corresponding to the detected temperature. The haptic sensation information may be generated such that the haptic sensation is presented at a low temperature when the detected temperature is low and the haptic sensation is presented at a high temperature when the detected temperature is high.

An example in a case where the sub-information acquisition unit 600 is the position sensor will be described. In a case where the sub-information acquisition unit 600 is the position sensor, the sub-information acquisition unit 600 estimates the change in the body of the main object on the basis of the detected position, and generates haptic sensation information. For example, in a case where the detected position is a high place and shortness of breath is likely to occur, haptic sensation information indicating vibration having a cycle similar to the cycle of breathing at the time of shortness of breath is generated. Information of the air temperature corresponding to the detected position may be acquired from an outside, and the haptic sensation information may be generated on the basis of the acquired information on the air temperature.

Although an example in which the second information (information not obtainable from the video signal of the imaging device 100) is recorded has been described, the information regarding the processing amount of the improvement in the quality may be corrected on the basis of the second information. For example, in a case where the emotion estimated in S703 is “calm”, the intensity of the haptic sensation information on the basis of the processing amount for the improvement in the quality may be reduced. Then, information after the correction and a signal after the improvement in the quality may be recorded in association with each other.

Although an example in which the second information is the haptic sensation information not obtainable from the video signal of the imaging device 100 has been described, the second information may not be the haptic sensation information. For example, information including at least one of the following pieces of information may be used as the second information.

Second video signal representing video outside imaging range of imaging device 100

Positional information indicating imaging position of imaging device 100

Temperature information indicating air temperature around imaging device 100

Information indicating expression of image capturing person of imaging device 100

Information indicating emotion of image capturing person of imaging device 100

Information indicating heart rate of image capturing person of imaging device 100

Haptic sensation information not obtainable from video signal of the imaging device 100 (for example, haptic sensation information on the basis of at least one of expression, emotion, and heart rate of image capturing person)

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to present a suitable haptic sensation even in a case where quality of a video signal or a sound signal is improved.

### Other Embodiments

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216318, filed December 11, 2024, which is hereby incorporated by reference herein in its entirety.

What is claimed is:

1. An electronic device comprising:
a processor; and
a memory storing a program which, when executed by the processor, causes the electronic device to
execute acquisition processing of acquiring at least one of a video signal and a sound signal,
execute improvement processing of improving quality of a signal to be acquired by the acquisition processing, and
execute control processing of recording a signal whose quality is improved by the improvement processing and information regarding a processing amount of the improvement processing in association with each other.

2. The electronic device according to claim 1, wherein the program, when executed by the processor, further causes the electronic device to
execute generation processing of generating haptic sensation information included in the information regarding the processing amount on a basis of the processing amount of the improvement processing.

3. The electronic device according to claim 2,
wherein the haptic sensation information indicates at least one of a frequency and an intensity of vibration for reproducing a haptic sensation, and
in the generation processing, at least one of the frequency and the intensity is controlled on a basis of the processing amount of the improvement processing.

4. The electronic device according to claim 1,
wherein the video signal is a signal of a video imaged by an imaging device, and
the improvement processing includes anti-vibration processing of removing vibration caused by vibration of the imaging device from a video represented by the video signal.

5. The electronic device according to claim 4,
wherein, in the anti-vibration processing, the vibration is removed from the video on a basis of an output of a motion sensor provided in the imaging device or a temporal change in the video signal.

6. The electronic device according to claim 5,
wherein the information regarding the processing amount includes information indicating the output of the motion sensor or the temporal change in the video signal.

7. The electronic device according to claim 4,
wherein the information regarding the processing amount includes information indicating a type and a magnitude of the vibration removed by the anti-vibration processing.

8. The electronic device according to claim 1,
wherein the improvement processing includes noise removal processing of removing a noise signal from the sound signal.

9. The electronic device according to claim 8,
wherein, in the noise removal processing, a preset type of noise signal is removed from the sound signal.

10. The electronic device according to claim 8,
wherein the information regarding the processing amount includes information indicating a type and a magnitude of the noise signal removed by the noise removal processing.

11. The electronic device according to claim 1,
wherein the program, when executed by the processor, further causes the electronic device to
execute second acquisition processing of acquiring information that regards the video signal and is not obtainable from the video signal, and
in the control processing,
a signal whose quality is improved by the improvement processing, the information regarding the processing amount of the improvement processing, and the information acquired by the second acquisition processing are recorded in association with each other, or
the information regarding the processing amount is corrected on a basis of the information acquired by the second acquisition processing, and the corrected information and the signal whose quality is improved by the improvement processing are recorded in association with each other.

12. The electronic device according to claim 11,
wherein the video signal is a signal of a video imaged by an imaging device, and
the information not obtainable from the video signal includes at least one of a second video signal representing a video outside an imaging range of the video signal, positional information indicating an imaging position of the video signal, temperature information indicating an air temperature at the imaging position, information indicating an expression of an image capturing person of the video signal, information indicating an emotion of the image capturing person, information indicating a heart rate of the image capturing person, and haptic sensation information not obtainable from the video signal.

13. A control method of an electronic device, comprising:
acquiring at least one of a video signal and a sound signal;
executing processing of improving quality of a signal to be acquired; and
recording a signal whose quality is improved and information regarding a processing amount of the processing in association with each other.

14. A non-transitory computer readable medium that stores a program, wherein the program causes a computer to execute a control method of an electronic device, the control method comprising:
acquiring at least one of a video signal and a sound signal;
executing processing of improving quality of a signal to be acquired; and
recording a signal whose quality is improved and information regarding a processing amount of the processing in association with each other.
